(19) United States
(12) Patent Application Publication
(10) Pub. No.: US 2005/0163898 A1
(43) Pub. Date: Jul. 28, 2005

(54) Article of commerce comprising edible substrate and game elements

(75) Inventors: Benito Alberto Romanach, Mason, OH (US); LuFang Wen, Mason, OH (US); John Humbert Baer, Cincinnati, OH (US); Gary James Dechert, Fairfield, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 11/010,969

(22) Filed: Dec. 13, 2004

Related U.S. Application Data
(60) Provisional application No. 60/539,172, filed on Jan. 26, 2004.

(51) Int. Cl. A23P 1/00

(52) U.S. Cl. 426/383

(57) ABSTRACT

An article of commerce comprising an edible substrate having an image which provides value beyond the aesthetic value of the image. In one aspect, the present invention provides an article of commerce comprising: (a) an edible substrate; (b) a first image disposed upon said edible substrate, wherein said first image comprises a first game element; (c) a second image disposed upon said edible substrate, wherein said second image comprises a second game element; and (d) optionally a container for containing said edible substrate. The first game element and the second game element provide elements of a game. In a preferred embodiment, the edible substrate comprises a fabricated snack chip.

### CROSS REFERENCE TO RELATED APPLICATIONS

This application claims the benefit of priority to U.S. Provisional Application Ser. No. 60/539,172, filed Jan. 26, 2004, which is herein incorporated by reference.

### FIELD OF INVENTION

The present invention relates to articles of commerce comprising edible substrates, and more particularly to edible substrates having an image disposed thereon.

### BACKGROUND OF THE INVENTION

Food provides more than just physical sustenance. Food also provides enjoyment through means such as visual appeal. Many popular food items, such as cookies, cakes, and candies, comprise some sort of decoration that makes the food item more visually appealing. The value that such decoration provides to the consumer, however, is limited by the visual aesthetics of the decoration. This leads to an increased reliance on the decorative aspects of the decoration itself to engage the consumer and encourage the consumer to enjoy the food item.

Accordingly, it would be desirable to provide a food item comprising an image which provides more than just aesthetic value. It would be especially desirable to provide such a food item wherein the value of the image is not dependent upon aesthetics alone. It would also be desirable for the food item to provide enhanced value to the consumer.

### SUMMARY OF THE INVENTION

The present invention provides an article of commerce comprising an edible substrate having an image which provides value beyond the aesthetic value of the image. As a result, the edible substrate provides enhanced value to the consumer.

In one aspect, the present invention provides an article of commerce comprising:
(a) an edible substrate;
(b) a first image disposed upon said edible substrate, wherein said first image comprises a first game element;
(c) a second image disposed upon said edible substrate, wherein said second image comprises a second game element; and
(d) optionally a container for containing said edible substrate;
wherein said first game element and said second game element provide elements of a game.
   In a preferred embodiment, the edible substrate comprises a fabricated snack chip.

The edible substrate can be used to play a game, thus enhancing its value beyond that of a mere edible. Such enhancement leads in turn to a sustained level of consumer engagement and stimulation, increased product desirability, and also serves to build a stronger relationship between the article manufacturer and the consumer.

In another aspect, the present invention provides an article of commerce comprising at least a first and a second edible substrate. The first and the second substrates each comprise game elements, but each of the two substrates is used to play a different type of game. By providing more than one type of game, the value that the article brings to the consumer is enhanced even further.

These and other aspects of the invention will become apparent from the following disclosure and appended claims.

All documents cited herein are, in relevant part, incorporated herein by reference; the citation of any document is not to be construed as an admission that it is prior art with respect to the present invention.

### BRIEF DESCRIPTION OF THE DRAWINGS

FIG. 1. Top view of edible crisp shape with game elements disposed on concave surface.

FIG. 2. Perspective view of edible crisp of FIG. 1. This figure shows how the concave shape of the crisp is used to hide a game element.

FIG. 3. Bottom view of edible crisp shape with game elements disposed on convex surface.

FIG. 4. Perspective view of edible crisp of FIG. 3. This figure shows how the convex shape of the crisp is used to hide a game element.

FIG. 5. Edible crisp with game elements displaying referencing.

FIG. 6. Portion of a pamphlet providing answer to question in FIG. 5, as referenced by the second game element comprising the text: “See answer #22”.

FIG. 7. Edible crisp with game elements displaying differentiation. In this example, differentiation is achieved by a different font type, font size, font orientation. Also, the first and second game elements are separated by a line disposed between them.

FIG. 8. Edible crisp with game elements displaying full coding.

FIG. 9. Edible crisp with game elements displaying partial coding.

FIG. 10. Portion of container label providing a code to decipher the second game element of FIGS. 8 and 9.

### DETAILED DESCRIPTION OF THE INVENTION

The present invention provides an article of commerce comprising:
(a) an edible substrate;
(b) a first image disposed upon said edible substrate, wherein said first image comprises a first game element;
(c) a second image disposed upon said edible substrate, wherein said second image comprises a second game element; and
(d) optionally a container for containing said edible substrate;
wherein said first game element and said second game element provide elements of a game.
   A. Edible Substrate

As used herein, “edible substrate” or “substrate” includes any material suitable for consumption that is capable of having an image disposed thereon. Any suitable edible substrate can be used with the invention herein. Examples of suitable edible substrates can include, but are not limited to, snack chips (e.g., sliced potato chips), fabricated snacks (e.g., fabricated chips such as tortilla chips, potato chips, potato crisps), extruded snacks, cookies, cakes, chewing gum, candy, bread, fruit, dried fruit, beef jerky, crackers, pasta, hot dogs, sliced meats, cheese, pancakes, waffles, dried fruit film, breakfast cereals, toaster pastries, ice cream cones, ice cream, gelatin, ice cream sandwiches, ice pops, yogurt, desserts, cheese cake, pies, cup cakes, English muffins, pizza, pies, meat patties, and fish sticks.

The edible substrate can be in any suitable form. For example, the substrate can be a finished food product ready for consumption, a food product that requires further preparation before consumption (e.g., snack chip dough, dried pasta), or combinations thereof. Furthermore, the substrate can be rigid (e.g., fabricated snack chip) or non-rigid (e.g., gelatin, yogurt).

In addition, the edible substrate can include pet foods such as, but not limited to, dog biscuits and dog treats.

The article of commerce can comprise one or a plurality of edible substrates.

In a preferred embodiment, the substrate is a fried fabricated snack chip. The image can be disposed upon the snack chip by any suitable means. For instance, the image can be disposed on the chip dough before the dough is fried to make the fried fabricated snack chip, or the image can be disposed on the chip after it has been fried.

In one embodiment, the fabricated snack chip is a potato-based fabricated snack crisp, such as that described by Lodge in U.S. Pat. No. 5,464,643, and Villagran et al. in U.S. Pat. No. 6,066,353. FIGS. 1 through 4 show examples of fabricated snack chips

B. Image Disposed Upon Said Edible Substrate

The edible substrate comprises an image disposed thereon. The image can comprise one or more text, graphic, or combinations thereof. As used herein, “text” means one or more alpha-numeric symbols. Text can include letters, numbers, words, and combinations thereof. As used herein, “graphic” means pictorial representation.

For instance, the graphic can include objects, symbols, scenes, people, animals, toys, or characters. Suitable characters can include cartoon characters and licensed characters, as well as characters associated with popular personalities in the media, advertising, or well known in the particular culture.

Furthermore, images can be in the form of full or partial words, numbers, clues, hints, jokes, revelations, trivia quizzes, photographs, pictures, puzzles, stories, games, or sequence of events. For example, the image can comprise the question portion of a trivia quiz.

As used herein, “disposed upon” or “disposed on” means that one component can be integral with another component, or that one component can be a separate structure bonded to or placed on another component. Thus, the image can be applied directly or indirectly to the edible substrate, applied to a material that is placed on the edible substrate, applied within the edible substrate, or other variations or combinations thereof. In particular embodiments, the image can be printed, sprayed, or otherwise applied directly on the surface of the substrate. In other embodiments, the image can be applied to a material placed on the surface of the substrate. The image can be located on the outer surface of the substrate, or can be located on the interior of the substrate, or combinations thereof.

Any suitable means of disposing an image on the substrate can be used herein. For example, the image can be printed, drawn, painted, or otherwise attached to the edible substrate. The image can be single-color or multi-color. The image can comprise dyes, pigments, other natural or synthetic substances, or combinations thereof.

In one embodiment, the image is printed on the substrate. Methods of printing can include, but are not limited to, laser, ink jet (e.g., thermal bubble jet, piezoelectric drop on demand, continuous ink jet), gravure, flexographic, and stamping.

In another embodiment, an edible sticker comprising an image is affixed to the substrate.

In another embodiment, a thin film comprising an image is affixed to the substrate via edible adhesive.

In a preferred embodiment, an ink jet image is printed on a fabricated snack chip.

Furthermore, the image can be permanent or active. Permanent images include those that do not change before consumption of the edible substrate. Active images include those that can be modified by some means before consumption of the edible substrate.

For example, active images include those that can be visually modified. In one embodiment, an invisible image becomes visible when the substrate comes into contact with saliva (e.g., the substrate is licked). In another embodiment, the image becomes visible when the substrate is held under a black light source. In yet another embodiment, the visible image becomes invisible when the substrate comes into contact with saliva. In still another embodiment, the visible image disappears and a second, different, image appears when the substrate comes into contact with saliva.

C. Image Comprising a Game Element

Disposed upon the edible substrate are a first image and a second image. The first image comprises a first game element and the second image comprises a second game element. The first game element and second game element provide elements of a game that can be played by the consumer. FIGS. 1, 2, 3, 4, 5, 7, 8 and 9 show exemplary embodiments of edible substrates with first images (11), (21), (31), (41), (51), and (61) comprising first game elements, and second images (12), (22), (32), (42), (52), and (62) comprising second game elements.

As used herein, “consumer” includes any purchaser, potential purchaser, user, or potential user of the article of commerce.

As used herein, “game element” means any text, graphic, or combination of text and graphic element that can be used in combination with another game element to play a game.

As used herein, “game” means an activity that provides entertainment or amusement by using the game elements provided. The game can be educational, fun, mentally stimulating, informative, or otherwise engaging. For instance, games can include, but are not limited to, question and answer games (e.g., trivia, jokes, riddles, question and multiple choice), mathematical problems and solutions, pattern recognition games, cryptograms, spelling games (e.g., supply the missing letter), completion games (e.g., phrases, words), word games (e.g., synonyms, antonyms, language translation), coded message and decoding code, and graphical clues and solution.

Furthermore, the game types herein can include graphical games, hybrid games and text games. As used herein, “graphical game” means a game wherein both the first game element and second game element are graphical. As used herein, “text game” means a game wherein both the first game element and second game element are text. As used herein, “hybrid game” means a game having a combination of text and graphical elements within and/or across game elements.

It has been discovered that children learning to read cannot readily rearrange a statement into a question and answer format, and that having a first game element in readily sharable form (e.g., a question) better enables the socialization of children with others. In one embodiment, the first game element of the game can be read as disposed on the edible by one consumer to engage another consumer into dialogue, without needing to rearrange a statement. In another embodiment, the first game element provides a means to determine the second game element. In a particular embodiment, the first game element is a question that can be answered by the second game element. For example, the first game element may comprise the text: “What is man's best friend?”, while the second game element may comprise the text: “dog”. In another embodiment, the first game element is a mathematical expression and the second game element is the solution. For example, the first game element may comprise the text and graphics: “3×7=”, while the second game element comprises the text: “21”. In yet another embodiment, the first game element is a part of a sentence that can be completed by the second game element comprising the rest of the sentence. For example, the first game element may comprise the text: “A synonym of beautiful is:”, while the second game element may comprise the text: “pretty”. In yet another embodiment, the first game element may comprise a combination of graphics and text that may be answered by the second game element. For example, the first game element may comprise the combination of text and graphics: “What is next in the pattern □□♦□□♦□□?”, while the second game element comprises the graphic: “♦”.

In one embodiment, the first game element includes a prompt, punctuation mark, word, or cue that signals to the consumer to provide an answer or a response to a question or to an incomplete statement provided by the first game element. This can include, but is not limited to, a question mark, a colon, a symbol, or some other indicator that an answer or solution is being called for. Additionally, this can help to create a visual and/or mental separation between the first game element and the second game element.

Furthermore, it has surprisingly been found that when consumers play games comprising text according to the present invention, their level of socializing in a given time period especially increases while their level of edible consumption (quantity of edibles consumed) decreases for the same time period. This can be desirable, since this effect can help reduce the consumption of edibles in a given time period (e.g., an after-school snack before dinner).

In one embodiment, the article of commerce comprises a first edible substrate and a second edible substrate. The first edible substrate comprises the first and second game elements of a first game. The second edible substrate comprises the first and second game elements of a second game. The first game and the second game are of different types.

In one embodiment, both the first game element and the second game element are disposed on the same side of the edible substrate. In a particular embodiment, a fabricated snack chip comprises a first game element and a second game element disposed upon the same side of the edible substrate. As used herein, a “side” is a surface delimited by a continuous outer perimeter edge of the edible substrate. In this embodiment, the fabricated snack chip is shaped in a manner such as those curved snack chips described in U.S. Pat. No. 3,498,798 to Bauer et al., issued Mar. 3, 1970. For example, FIGS. 1, 2, 3, 4, 5, 7, 8 and 9 show first sides (16), (26), (36), (46), (56), (66) and second sides (18), (28) separated by the perimeter edges (17), (27), (37), (47), (57), (67) of fabricated snack chips (1), (2), (3), (4), (5), (6).

Disposing both the first and the second game elements on the same side of the edible substrate can be desirable in order to simplify manufacturing. However, when both the first and the second game elements are disposed on the same side, problems can arise with the premature disclosure of the second game element. For instance, when viewing the first game element, the consumer may also accidentally view the second, thus depriving himself of the opportunity to play the game.

In order to control the exposure of one or more game elements, the exposure of at least a portion of a game element can be controlled by means including referencing, differentiating, coding, hiding, prelocating, and/or combinations thereof. This can be especially desirable when both the first game element and the second game element are disposed on the same side of the edible substrate.

1. Referencing

Referencing can be used to prevent the consumer from viewing the answer or solution by supplying the answer or solution at a location other that the edible substrate. For example, instead of providing an answer to the question on the edible substrate, a reference to where the answer can be found in another source is provided.

In one embodiment, the first game element is a question and the second game element is a number. The number refers the consumer to another source, such as a pamphlet or website, where the answer to the question can be found. FIG. 5 shows an example of using referencing, wherein the second image (32), printed on the side (36) of the edible substrate (3), comprises the text: “See answer #22” a second game element. The first image (31) is printed on side (36).

FIG. 6 shows a portion of a pamphlet providing an answer to the first game element in the first image (31) of the edible substrate (3) in FIG. 5, as referenced by the second game element (32).

2. Differentiating

Differentiating can be used to differentiate the first game element from the second game element, such as to assist the consumer to focus on the first game element before using the second game element.

In one embodiment, the first game element is a question and the second game element is an answer. The first game element is printed in large, easy to read text. The second game element, however, is more difficult to read. For instance, the second game element can be upside down, in smaller font size, in a different font, is of lighter color, is of a color that is similar to the substrate such that it is more difficult to see, is in italics, is stricken through (simple line or other scratches) such that it is difficult to read, or the question is highlighted with a box or by other means (e.g., an asterisk or other graphic) to signal where the consumer's eye should focus.

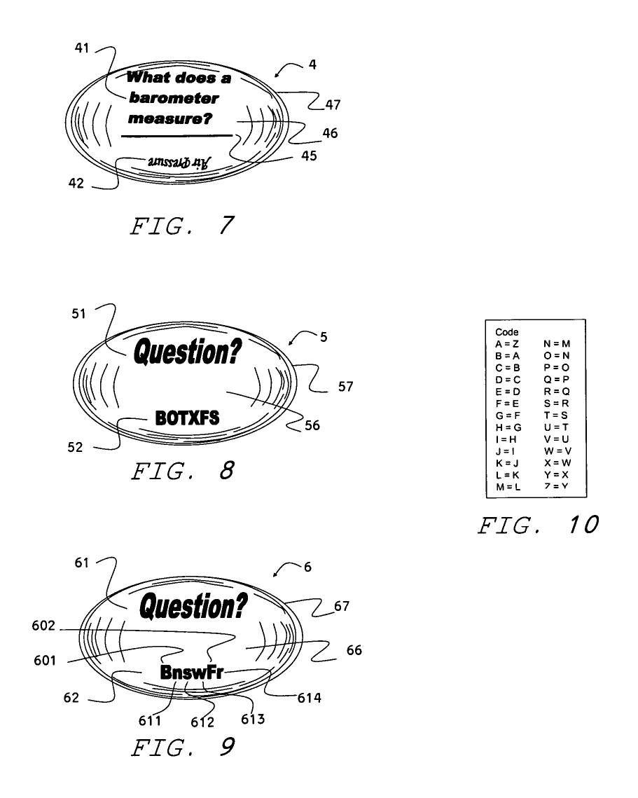

FIG. 3 shows an example of an edible substrate (2) with first image (21) comprising the first game element “What is the world's most popular sport?” and a second image (22) comprising the second game element “Soccer” written upside down. FIG. 7 shows an example of an edible substrate (4) with first image (41) comprising the first game element “What does a barometer measure?” and a second image (42) comprising the second game element “Air Pressure” written upside down, in a smaller font size than the first game element and with a different font than the first game element that is more elaborate and more difficult to read. FIG. 7 also shows an example of a separating feature (45) between first image (41) and second image (42) to aid the consumer to visually separate the first game element from the second game element.

3. Coding

A code can be used to decipher the second game element such that it is not readily accessible. For instance, the second game element can be a word written in reverse order, or a code can be made available in the package to decipher the answer (like A=B, B=C and so on).

In one embodiment, to simplify decoding for the consumer, only part of answer may be coded, as designated by a different font or color or designation for the specific letters or symbols. In another embodiment, only consonants are provided for the answer, and vowels are represented by symbols (e.g., coding a portion of the second game element).

FIGS. 8 and 9 shows examples of full coding and partial coding respectively. In the edible substrate (5) of FIG. 8, a second image (52) comprises a second game element that is coded. This second game element comprises the text “BOTXFS” which may be decoded by the exemplary decoding means provided in FIG. 10, to reveal that in this particular example the text “BOTXFS” means “ANSWER”. In the edible substrate (6) of FIG. 9, a second image (62) comprises a second game element that is partially coded. This second game element comprises the text “BnswFr” which may be decoded by the exemplary decoding means provided in FIG. 10, to reveal that in this particular example the text “BnswFr” means “ANSWER”. Instructions provided to the consumer could indicate that only capital case letters (601) and (602) are coded and that lower case letters (611), (612), (613) and (614) are not coded.

4. Hiding

The second game element can be hidden from view. For example, the second game element can be printed with invisible ink that becomes visible upon a chemical reaction (like with saliva) or under a special light, or heat.

In another embodiment, a question and an answer are printed on a convex surface such that the edible substrate can be oriented to reveal only the question in the visible part of the convexity. Upon reaching a new orientation, the answer could be made visible to the eye as well, when desired by the consumer. This embodiment is demonstrated by FIGS. 3 and 4, wherein a direct view from the bottom of the edible substrate (2) as shown in FIG. 3, reveals both the first image (21) comprising a first game element “What is the world's most popular sport?”, and the second image (22) comprising the second game element “Soccer”, which are both disposed upon the same side (26). FIG. 4 shows that holding the edible substrate (2) in a specific orientation can hide the second image (22) from view, while still making the first image (21) visible.

Furthermore, in another embodiment, some delineation means between question and answer can be provided to help discern up to what point to look at to avoid premature exposure of the answer. FIG. 7 shows delineation (45) between a first image (41) comprising a question, and second image (42) comprising an answer.

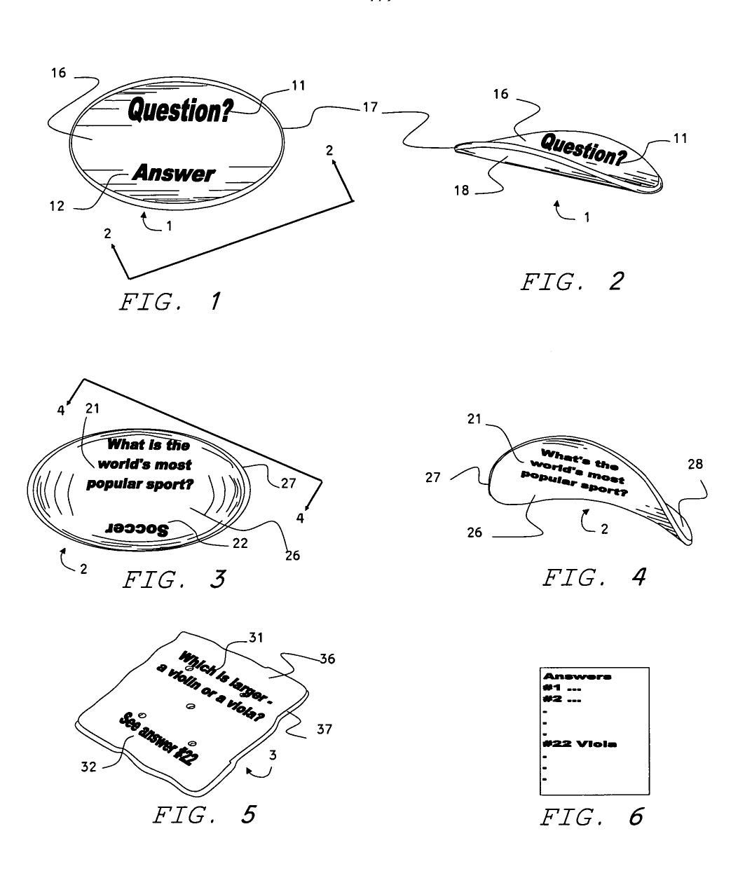

In another embodiment, the first and second image are both printed on the concave surface of a fabricated snack chip such that the answer can be at least partially hidden from view by the features of the chip shape until desired, while the question remains visible. This embodiment is demonstrated by FIGS. 1 and 2, wherein a direct view from the bottom of the edible substrate (1) as shown in FIG. 1, reveals both the first image (11) comprising a first game element “Question?”, and the second image (12) comprising the second game element “Answer”, which are both disposed upon the same side (16). FIG. 2 shows that holding the edible substrate (1) in a specific orientation can hide the second image (12) from view, while still making the first image (11) visible.

In another embodiment, the second game element is provided interspersed with confusing matter. Said confusing matter could be text and/or graphics to create confusion that could be filtered with special viewing device because of a color difference between the second game element and the confusing matter. For example, the second game element may comprise the word “dog” in color red, and confusing matter comprising scratches, symbols and other letters in color blue, disposed directly above the word “dog” to make it difficult to read. Upon using a blue colored device to view the second game element, the word dog would be readily visible.

In another embodiment, the first and second game elements are disposed on the edible substrate with different colors, such that dual colored glasses with the same corresponding colors could be used to view the first game element only with one eye, and to view the second game element with the other eye.

5. Prelocating

In this embodiment, the answer is located in a known, pre-determined location, such that the consumer knows where not to look in order to keep the answer hidden from view until desired.

In one embodiment, the edible substrate is shaped in a recognizable shape to assist a consumer to determine how to hold and orient the substrate when holding it such that the consumer can see the question yet avoid viewing the answer until desired.

For example, a question and an answer are both printed on a fabricated snack chip. The question is printed toward one edge of the chip and the answer is printed upside down near the opposing edge near a notch in the chip. A notch in the chip signals to the consumer that the answer is located on that region of the chip, thus enabling the consumer to hide that portion of the chip from view until desired.

In another embodiment, the first and second game elements are located in equivalent positions from one edible substrate to the next, providing, therefore, predictability to the consumer regarding where to expect the first game element and where to expect the second. This can be particularly beneficial when edible substrates are in a sequential arrangement such as a stack common of potato crisps like Pringles or arranged in a stack like crackers. This can be particularly beneficial in combination with the hiding mechanism described earlier. In this manner, a consumer could hold a stack of crisps in certain way to only be able to view a first game element, and then remove a crisp from the stack when ready to view the second game element. Maintaining the stack unmoved, can then automatically retain hidden the second game element of a subsequent edible substrate.

In some embodiments, the text is elongated to correct the visual aspect ratio of the characters when viewed from an angle versus directly when such characters are printed on a curved surface.

D. Optionally a Container for Containing Said Edible Substrate

Optionally, the article of commerce comprises a container for containing said edible substrate. Any container from which the edible substrate can be dispensed, presented, displayed, or stored is suitable. Suitable containers include, but are not limited to, bags, canisters, boxes, bowls, plates, tubs, and cans. In one embodiment, the container is a round cylindrical canister that can contain fabricated potato crisps. In another embodiment, the container is a plastic tub that can contain fabricated potato crisps.

In one embodiment, a container comprises a plurality of edible substrates, wherein more than one edible substrate in said container comprises the same images. (e.g., at least two the same).

In another embodiment, a container comprises a plurality of edible substrates, wherein at least one edible substrate comprises an image. (e.g., at least one printed potato crisp in a container).

In another embodiment, a container comprises a plurality of edible substrates, wherein at least two edible substrates have first and second images disposed thereon. At least two of the edible substrates have first and second images that are different from one another.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. An article of commerce comprising:
(a) an edible substrate;
(b) a first image disposed upon said edible substrate, wherein said first image comprises a first game element;
(c) a second image disposed upon said edible substrate, wherein said second image comprises a second game element; and
(d) optionally a container for containing said edible substrate;
wherein said first game element and said second game element provide elements of a game.

2. The article of claim 1, wherein said first image comprises a text image.

3. The article of claim 2, wherein said second image comprises a text image.

4. The article of claim 1, wherein said first image comprises a question and wherein said second image comprises an answer to said question.

5. The article of claim 3, wherein said first image comprises a question and wherein said second image comprises an answer to said question.

6. The article of claim 4, wherein the exposure of at least a portion of said answer is controlled by a method selected from the group consisting of referencing, differentiating, coding, hiding, prelocating, and combinations thereof.

7. The article of claim 5, wherein the exposure of at least a portion of said answer is controlled by a method selected from the group consisting of referencing, differentiating, coding, hiding, prelocating, and combinations thereof.

8. The article of claim 1, wherein the exposure of at least a portion of said second image is controlled by a method selected from the group consisting of referencing, differentiating, coding, hiding, prelocating, and combinations thereof.

9. An article of commerce comprising:
(a) a container;
(b) a first edible substrate comprising the first and second game elements of a first game, wherein said first game type is selected from the group consisting of graphical games, hybrid games, text games, and combinations thereof; and
(c) a second edible substrate comprising the first and second elements of a second game, wherein said second game type is selected from the group consisting of graphical games, hybrid games, text games, and combinations thereof;
wherein said first game type and said second game type are different, and wherein said first edible substrate and said second edible substrate are contained in the container.
